(19) United States
(12) Patent Application Publication
(10) Pub. No.: US 2005/0120310 A1
(43) Pub. Date: Jun. 2, 2005

(54) Information processing apparatus and display control method

(76) Inventors: Masaya Sahashi, Ome-shi (JP); Satoshi Kaneko, Iruma-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/994,943

(22) Filed: Nov. 22, 2004

(30) Foreign Application Priority Data
Nov. 28, 2003 (JP) 2003-400789

(51) Int. Cl. G06F 3/00

(52) U.S. Cl. 715/788; 715/800; 715/801; 715/815; 715/765; 715/747

(57) ABSTRACT

According to one embodiment, a CPU executes a zooming utility program in accordance with, e.g., the operation of an enlargement button or reduction button provided as user operation means. The zooming utility program executed by the CPU searches for running application programs, and enlarges/reduces display contents within the windows of the searched application programs.

### CROSS-REFERENCE TO RELATED APPLICATIONS

This application is based upon and claims the benefit of priority from the prior Japanese Patent Application No. 2003-400789, filed Nov. 28, 2003, the entire contents of which are incorporated herein by reference.

### BACKGROUND

1. Field

Embodiments of the present invention relate to a display control technique in an electronic device such as a personal computer.

2. Description of the Related Art

Recently, personal computers of various types such as a notebook type and desktop type have been developed, become commercially available, and have widely prevailed. A personal computer of this type generally adopts a so-called graphical user interface (GUI) capable of executing various operations including activation of a program with a pointing device such as a mouse or touch pad. Various methods have conventionally been proposed for user-friendly presentation of information by the GUI (see, e.g., Jpn. Pat. Appln. KOKAI Publication No. 4-243422).

In recent personal computers, a plurality of application programs can be run in parallel by setting a plurality of display areas called windows or the like on a single screen displayed on an LCD, CRT, or the like. The operability can be improved by enlarging/reducing the display contents of running application programs at once.

However, the enlargement/reduction function on the conventional screen display fails to specifically enlarge/reduce the frames of windows and their display contents. For example, only the menu area is enlarged, as described above, or all pieces of information including information outside the window that is not intended by the user are enlarged/reduced.

### BRIEF DESCRIPTION OF THE SEVERAL VIEWS OF THE DRAWING

The accompanying drawings, which are incorporated within and constitute a part of the specification, illustrate presently preferred embodiments of the invention, and together with the general description given above and the detailed description of the preferred embodiments given below, serve to explain the principles of the invention.

FIG. 1 is a view showing the outer appearance of an information processing apparatus according to an embodiment of the invention;

FIG. 2 is an exemplary block diagram showing the system configuration of a computer according to one embodiment of the invention;

FIG. 3 is a table showing an example of the structure of an application lookup table (TBL-A) held in the computer according to one embodiment of the invention;

FIG. 4 is table showing an example of the structure of a zooming utility property setting table (TBL-B) held in the computer according to one embodiment of the invention;

FIG. 5 is a table showing an example of the structure of a zooming process activation table (TBL-C) 213 held in the computer according to one embodiment of the invention;

FIG. 6 is an exemplary flowchart showing the processing sequence of a zooming utility program according to one embodiment of the invention;

FIG. 7 is an exemplary view showing the first state (before enlargement) of a batch enlargement display example of display contents within windows by the process of the zooming utility program according to one embodiment of the invention;

FIG. 8 is an exemplary view showing the second state (after enlargement) of the batch enlargement display example of display contents within the windows by the process of the zooming utility program according to one embodiment of the invention;

FIG. 9 is an exemplary view showing the third state (in canceling minimization) of the batch enlargement display example of display contents within the windows by the process of the zooming utility program according to one embodiment of the invention;

FIG. 10 is an exemplary view showing the first modification of an operation means according to one embodiment of the invention; and

FIG. 11 is an exemplary view showing the second modification of the operation means according to one embodiment of the invention.

### DETAILED DESCRIPTION

Embodiments of the present invention will be described below with reference to the several views of the accompanying drawing. In general, one embodiment of the invention relates to an information processing apparatus that is capable of displaying content produced by a running program within a window on a display screen. The information processing apparatus comprises an operation unit, a detection unit configured to detect the running program, and a display control unit configured to enlarge or reduce a display content of the program detected by the detection unit within the window in accordance with an operation of the operation unit.

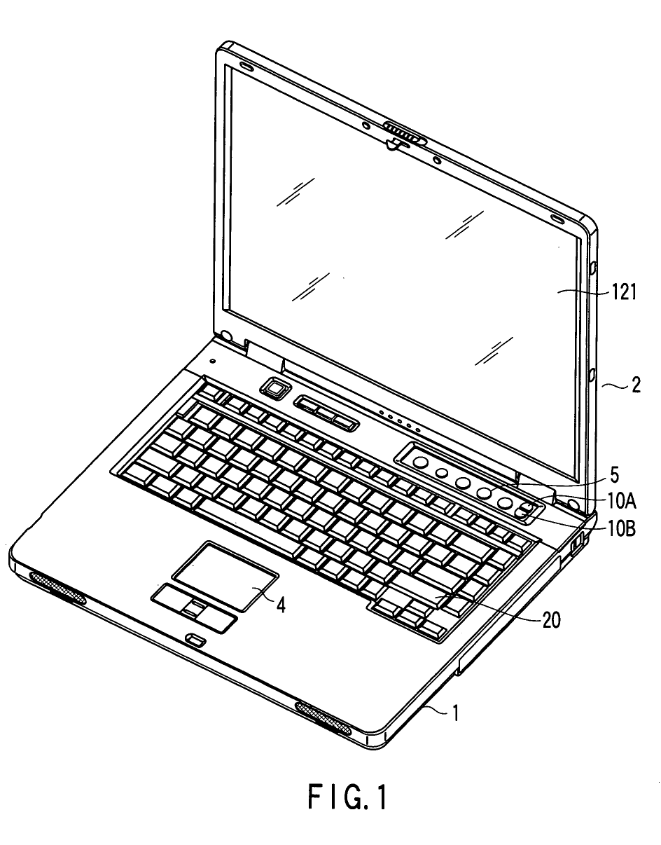

FIG. 1 is a view showing the outer appearance of an information processing apparatus according to the embodiment of the present invention. According to this embodiment of the invention, the information processing apparatus is configured as a notebook-type portable personal computer which can be driven by a battery. Of course, the information processing apparatus may be deployed in other embodiments such as a desktop computer, a handheld (e.g., personal digital assistant, portable computer, etc.), cellular telephone, and the like.

As shown in FIG. 1, the computer comprises a computer main body 1 and display unit (display unit housing) 2. The computer main body 1 has a low-profile box-like housing, and the upper surface of the housing is equipped with a keyboard 20. A handrest is formed on the upper surface of the housing in front of the keyboard 20. A touch panel 4 is arranged at almost the center of the handrest.

An operation unit 5 is also arranged on the upper surface of the housing between the keyboard 20 and a hinge which pivotally supports the display unit 2. The operation unit 5 comprises an enlargement button 10A and reduction button 10B (to be described later). The display unit 2 incorporates a display device 121 (e.g., a liquid crystal display “LCD”). The display unit 2 is attached to the computer main body 1 via the hinge to be pivotable between an open position and a closed position.

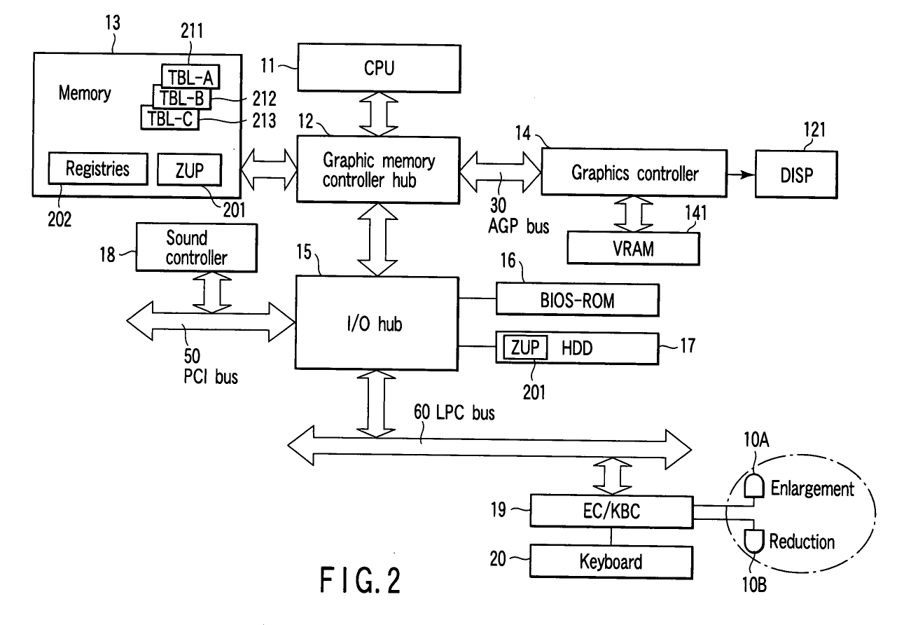

FIG. 2 is an exemplary block diagram showing the system configuration of the computer. As shown in FIG. 2, the computer comprises a CPU 11, a graphic memory controller hub 12, a memory (main memory) 13, a graphics controller 14, a video RAM (VRAM) 141, an input/output (I/O) hub 15, a BIOS ROM 16, a hard disk drive (HDD) 17, a sound controller 18, a keyboard embedded controller (EC/KBC) 19, the keyboard 20, the display device (DISP) 121, and the like.

The enlargement button 10A and reduction button 10B shown in FIG. 1 are provided as a user interface. When the enlargement button 10A or reduction button 10B is activated, the keyboard embedded controller 19 issues an event notification to the CPU 11. The CPU 11 then executes display control software to enlarge/reduce display contents within each running window in accordance with the operation. This processing sequence will be described later.

The CPU 11 is employed to control the operation of the computer. The CPU 11 executes various processes in accordance with an operating system (OS), application programs, utility programs, and the like which are loaded from the hard disk drive 17 into the memory 13. One of the utility programs is a zooming utility program 201.

The memory 13 is adapted to store the zooming utility program (ZUP) 201, an application lookup table (TBL-A) 211 which is looked up by the zooming utility program 201, a zooming utility property setting table (TBL-B) 212, and a zooming process activation table (TBL-C) 213. The memory 13 also stores registries 202 each having setting information of each running window. The zooming utility program 201 is loaded from the hard disk drive 17. Examples of the structures of the application lookup table (TBL-A) 211, zooming utility property setting table (TBL-B) 212, and zooming process activation table (TBL-C) 213 will be explained later.

The zooming utility program (ZUP) 201 executes an enlargement/reduction process for display contents within each window and an enlargement/reduction process for icons on the desktop serving as a basic screen by looking up the application lookup table (TBL-A) 211, zooming utility property setting table (TBL-B) 212, zooming process activation table (TBL-C) 213, and the like. In the icon enlargement/reduction process, icons on the desktop are enlarged/reduced and displayed by rewriting pieces of setting information on the icons on the desktop that are contained in the registries 202. Details of the enlargement/reduction process function (zooming process function) including the enlargement/reduction process for display contents within each window will be explained later.

The graphics controller 14 controls the display device (DISP) 121 under the control of the operating system (OS) executed by the CPU 11. Also, the graphics controller 14 controls external display devices connected via various external display connection interfaces (not shown) such as a cathode ray tube (CRT) terminal, digital video interface (DVI) terminal, and television (TV) terminal.

The keyboard embedded controller (EC/KBC) 19 is an integrated device including a microprocessor which implements the functions of system power management, a keyboard controller, and the like. The keyboard embedded controller 19 performs an input process through the enlargement button 10A and reduction button 10B in addition to the keyboard 20. When the enlargement button 10A or reduction button 10B is pressed, the keyboard embedded controller 19 notifies the CPU 11 of a display control command accompanying the operation. The CPU 11 executes the zooming utility program (ZUP) 201 upon reception of the display control command accompanying information associated with activation of the enlargement button 10A or reduction button 10B from the keyboard embedded controller 19.

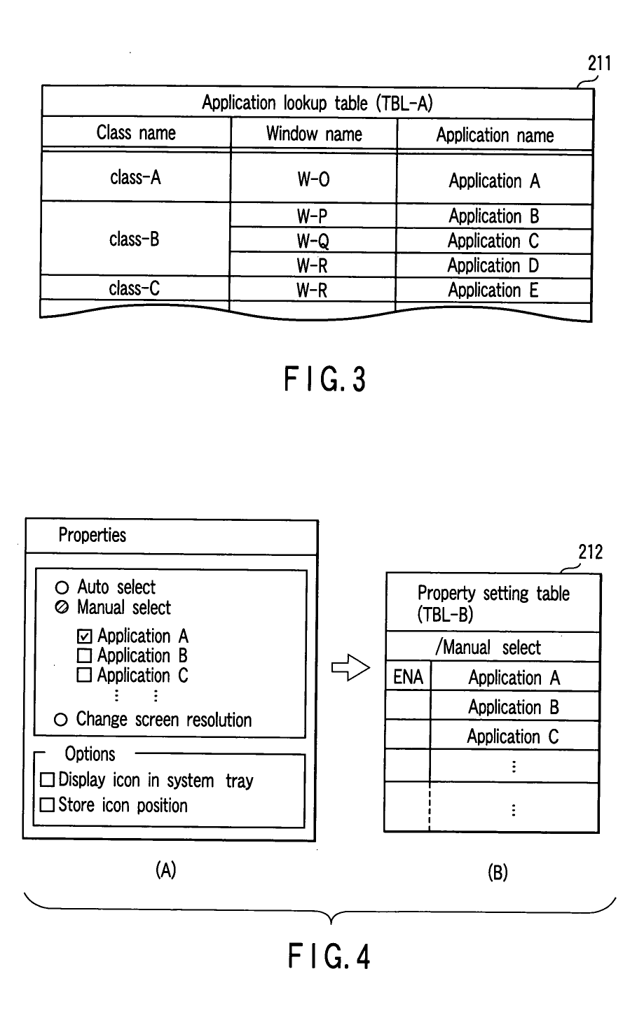

FIGS. 3 to 5 show examples of the structures of various tables looked up by the zooming utility program (ZUP) 201.

FIG. 3 shows an example of the structure of the application lookup table (TBL-A) 211. In the application lookup table (TBL-A) 211, the class names, window names, and application names of various application programs that may be processed by the system are registered in correspondence with each other. Using the application lookup table (TBL-A) 211, an application program can be specified on the basis of the class name or the class name and window name.

FIG. 4 shows an example of the structure of the zooming utility property setting table (TBL-B) 212. Contents set in the zooming utility property window shown in FIG. 4(A) are set and held in the property setting table (TBL-B) 212 shown in FIG. 4(B). The zooming utility property window shown in FIG. 4(A) provides the same operation procedures as, for example, the setting of the mouse property, and items shown in FIG. 4(A) can be set. This example enables auto/manual setting of the zooming utility function, setting of a target application in manual setting, display setting of the property icon in the system tray, and setting of the icon display position before change on the desktop. These setting contents are held in the property setting table (TBL-B) 212 shown in FIG. 4(B). Note that the table can set only application programs having the zooming process function (zooming process routine). Applications having no zooming process function are excluded from search targets in manual setting.

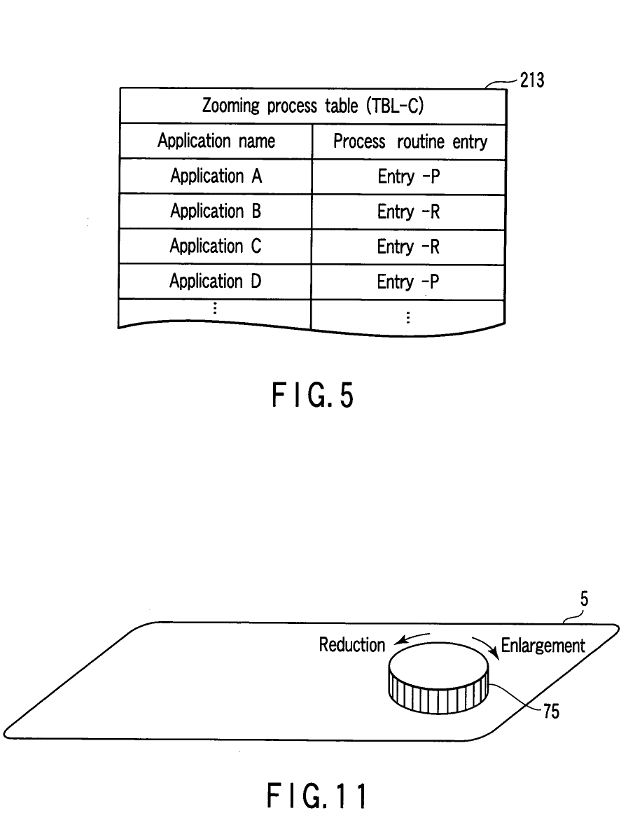

FIG. 5 shows an example of the structure of the zooming process activation table (TBL-C) 213. Various application programs that may be processed by the system, and call destinations (entries) for calling an enlargement/reduction process routine (zooming process function) associated with display of the application programs, are registered in correspondence with each other. By looking up the zooming process activation table (TBL-C) 213, the zooming process function (zooming process routine) of a specified application program can be called.

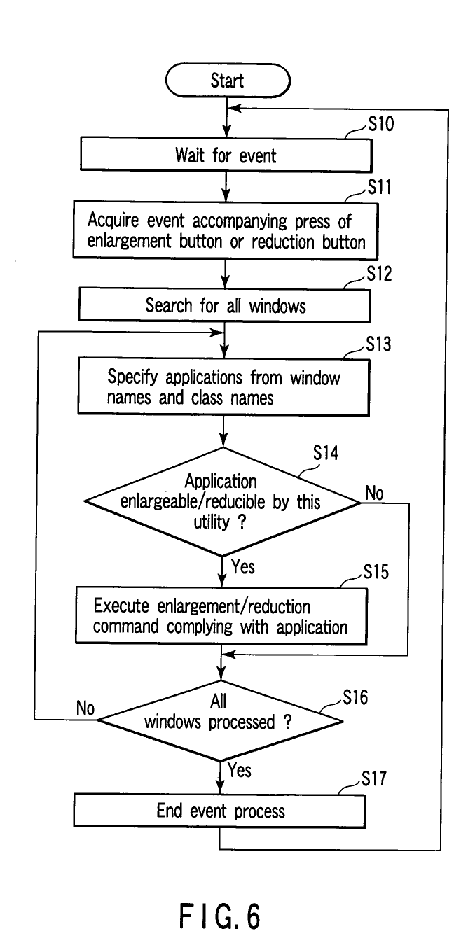

FIG. 6 is an exemplary flowchart showing the processing sequence of the zooming utility program 201.

When the enlargement button 10A or reduction button 10B on the upper surface of the housing of the computer main body 1 is operated, the keyboard embedded controller 19 notifies the CPU 11 of an event accompanying the operation of the enlargement button 10A or reduction button 10B (block S10). The CPU 11 receives the event notification accompanying button operation from the keyboard embedded controller 19 (block S11). The CPU 11 searches for the class names or class names and window names of all running windows by an inquiry to the operating system (OS) in accordance with the zooming utility program 201 stored in the memory 13 (block S12). By looking up the application lookup table (TBL-A) 211, the CPU 11 specifies application programs which are to display information in the windows (block S13).

By looking up the zooming utility property setting table (TBL-B) 212, the CPU 11 determines whether each of the application program has the enlargement/reduction function (block S14). If an application program has the enlargement/reduction function (YES in block S14), the CPU 11 calls the zooming process function (zooming process routine) of the specified application program by looking up the zooming process activation table (TBL-C) 213. The CPU 11 executes a zooming process complying with the operation of the enlargement button 10A or reduction button 10B (block S15).

After a series of processes for a given window has completed, the CPU 11 determines whether all the windows have been processed (block S16). If an unprocessed window remains (NO in block S16), the CPU 11 repeats processes from block S13 for the window. If all the windows have been processed (YES in block S16), the CPU 11 ends the processes for the current event (block S17), and returns to block S10 to wait for another event.

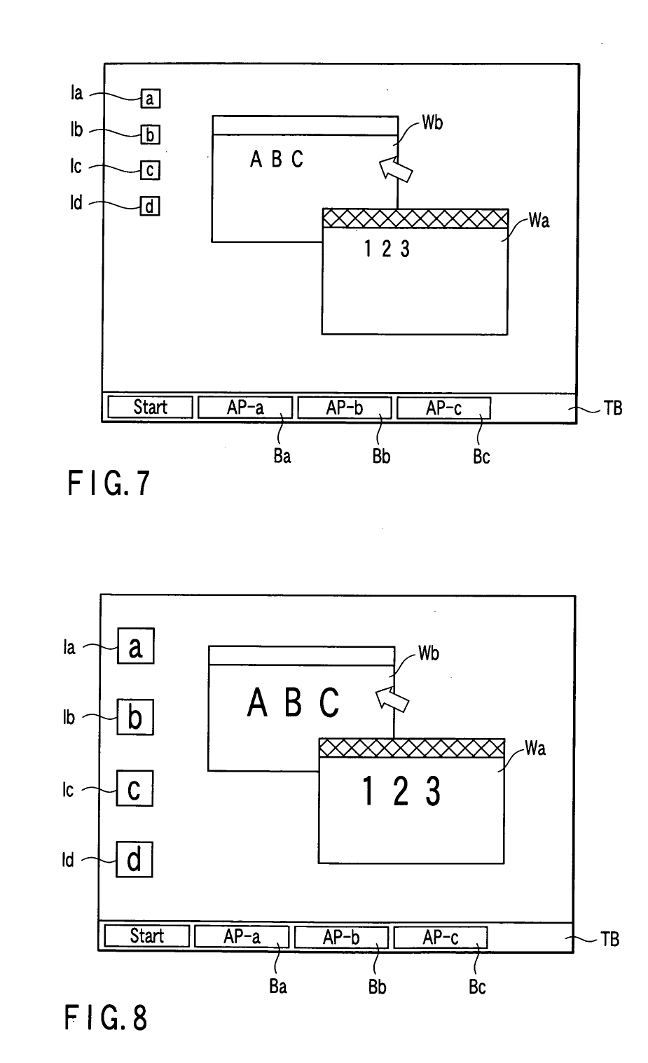

FIGS. 7 and 8 are exemplary views showing a batch enlargement display example of display contents within running windows by the process of the zooming utility program 201.

The display device 121 of the computer system exhibits a screen display shown in FIG. 7. More specifically, two windows Wa and Wb are open on the desktop serving as a basic screen, and of these windows, the window Wa becomes active. Two different application programs display pieces of information within the windows Wa and Wb. The display area of a task bar TB is positioned at a lower portion on the desktop. The task bar TB displays three task buttons Ba, Bb, and Bc representing running application programs. An application program represented by the task button Ba displays information within the window Wa. An application program represented by the task button Bb displays information within the window Wb. A window in which an application program represented by the task button Bc displays information is minimized.

To enlarge displays within the windows Wa and Wb, the user presses the enlargement button 10A. In response to this, the keyboard embedded controller 19 notifies the CPU 11 of an event accompanying button operation, as described above. The CPU 11 executes enlargement display control according to the zooming utility program 201.

FIG. 8 is an exemplary view showing an example of the screen display of the display device 121 after the enlargement button 10A is pressed. As shown in FIG. 8, display contents within both the active window Wa and inactive window Wb, all open windows on the desktop for example, are enlarged and displayed together.

Enlargement display control based on press operation of the enlargement button 10A is executed so that display contents are enlarged stepwise at a predetermined scaling factor every time the enlargement button 10A is pressed. In other words, when the enlargement button 10A is pressed while the display device 121 exhibits the screen display shown in FIG. 8, the display contents are enlarged by one more scaling factor.

When the reduction button 10B is pressed while the display device 121 exhibits the screen display shown in FIG. 8, the keyboard embedded controller 19 notifies the CPU 11 of an accompanying event, and the CPU 11 executes reduction display control according to the zooming utility program 201. After the reduction button 10B is pressed, the screen display of the display device 121 returns to the state shown in FIG. 7. If the reduction button 10B is further pressed in this state, the display contents are reduced by one more scaling factor.

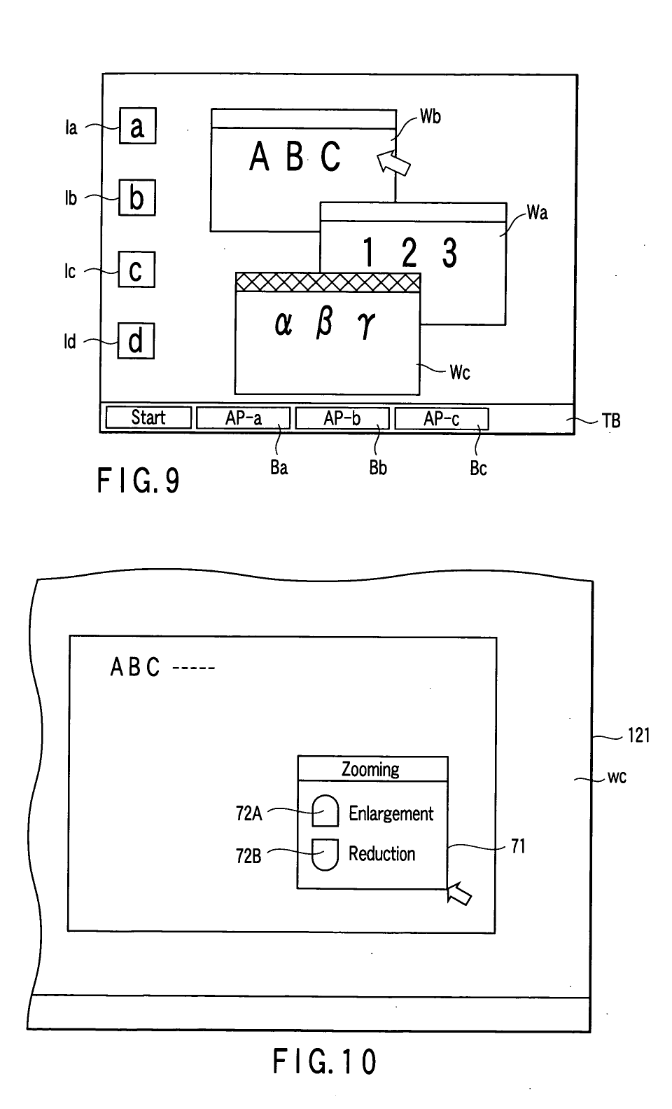

After the display device 121 exhibits the screen display shown in FIG. 8, that is, after the enlargement button 10A is pressed while the display device 121 exhibits the screen display shown in FIG. 7, the task button Bc is clicked with the mouse, and then minimization of the window Wc in which a corresponding application program displays information is canceled, as shown in FIG. 9. The window Wc is opened on the desktop and becomes active instead of the window Wa. Enlargement display control based on press operation of the enlargement button 10A is also effective for the application program whose window Wc has been minimized. Thus, display contents within the opened window Wc are enlarged by one scaling factor, similar to the windows Wa and Wb.

The zooming utility program (ZUP) 201 enlarges/reduces icons displayed on the desktop serving as a basic screen along with enlargement/reduction of display contents within the windows Wa and Wb. Upon reception of an event notification accompanying, e.g., press operation of the enlargement button 10A from the keyboard embedded controller 19, the CPU 11 updates the display size in the registry for icons (Ia, Ib, . . . in FIGS. 7 and 8) on the desktop at a predetermined enlargement factor. The icons (Ia, Ib, . . . ) on the desktop are enlarged and displayed.

In the above-described embodiment, the contents of an active window and icons on the desktop are enlarged/reduced and displayed by operating the enlargement button 10A and reduction button 10B on the upper surface of the housing of the computer main body 1. Another operation means can also be adopted in place of the enlargement button 10A and reduction button 10B. For example, when the right button of the mouse is clicked on the desktop, an enlargement/reduction operation window 71 with a display as shown in FIG. 10 is displayed. When an enlargement button 72A or reduction button 72B within the window 71 is selected, display contents within each window and icons on the desktop are enlarged or reduced. Also, as shown in FIG. 11, the operation unit 5 on the upper surface of the housing of the computer main body 1 can be equipped with an enlargement/reduction dial 75 instead of the enlargement button 72A and reduction button 72B. Dial operation of the enlargement/reduction dial 75 can successively enlarge and reduce display contents within each window and icons on the desktop. Moreover, single specific keys or specific combinations of keys on the keyboard 20 can be assigned to the functions of the enlargement button 10A and reduction button 10B.

In the above-described embodiment, display contents within each window and icons on the desktop are enlarged/reduced and displayed. The present invention can also be applied to a case in which a plurality of application programs have, e.g., the same display process function (process routine) other than the zooming process function and the process routines of all the application programs are executed at once with the enlargement button 10A and reduction button 10B.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus, comprising:
a user interface which is operated to adjust a sizing of content displayed within a plurality of display areas each associated with a running program; and
a display control unit configured to adjust the sizing of the plurality of display areas in response to an operation of the user interface.

2. The information processing apparatus according to claim 1, wherein sizing of contents within each of the plurality of display areas is adjusted with the sizing of the plurality of display areas.

3. The information processing apparatus according to claim 2, wherein the display control unit adjusts the sizing of the content within the plurality of display areas at a predetermined scaling factor.

4. The information processing apparatus according to claim 1, wherein each of the plurality of display areas is a window displayed on a display screen.

5. The information processing apparatus according to claim 2, wherein the display control unit comprises a processor executing a zoom utility program (ZUP) to access tables to call a process to either enlarge or reduce the sizing of the content with the plurality of display areas.

6. The information processing apparatus according to claim 5, wherein the user interface comprises (i) one of a button and a dial, and (ii) an embedded controller in communications with the processor and responsive to either depression of the button or rotation of the dial, the embedded controller to transfer a display control command in response to the operation of the button or the dial, the display control command identifying the process for the ZUP to call.

7. The information processing apparatus according to claim 5, wherein the display control unit to adjust the sizing of the content by modifying information contained with registries accessible by the processor.

8. The information processing apparatus according to claim 1, wherein the user interface comprises a dedicated operation button to designate enlargement or reduction of the sizing of the content.

9. The information processing apparatus according to claim 1, wherein the user interface comprises a dedicated operation dial to designate enlargement or reduction of the sizing of the content.

10. The information processing apparatus according to claim 1, wherein the user interface comprises a keyboard having at least one key designated for enlargement or reduction of the sizing of the content.

11. A display control method for an information processing apparatus, comprising
accepting a predetermined operation;
detecting a plurality of programs running on the information processing apparatus and each associated with a window displayed on a display screen; and
enlarging or reducing display content of the detected plurality of programs within the window.

12. A display control method according to claim 11, wherein one of the plurality of programs is a particular program that, in operation, produces an icon being the display content for the particular program.

13. The display control method according to claim 12, wherein the enlarging or reducing of the display content is conducted by rewriting setting information for the icon within a registry.

14. The display control method according to claim 11, wherein the enlarging or reducing of the display content comprises (i) displaying at least one operation button on the display screen, and (ii) enlarging or reducing the display content upon selection of the at least one operation button displayed on the display screen.

15. A method comprising:
detecting an event to adjust a sizing of content displayed within a plurality of display areas each associated with a running program; and
adjusting the sizing of the content within each of the plurality of display areas in accordance with an operation of a user interface.

16. The method according to claim 15, wherein the adjusting of the sizing of the content within each of the plurality of display areas is performed according to a predetermined scaling factor.

17. The method according to claim 16, wherein the user interface comprises a dedicated operation button located on an information processing apparatus having a display screen to designate enlargement or reduction of the sizing of the content, each depression of the dedicated operation button adjusts the sizing of the content with each of the plurality of display areas by the predetermined scaling factor.

18. The method according to claim 15, wherein the user interface comprises a dedicated operation button located on an information processing apparatus having a display screen to designate enlargement or reduction of the sizing of the content.

19. The method according to claim 15, wherein each of the plurality of display areas is a window.
